(19) United States
(12) Patent Application Publication
(10) Pub. No.: US 2005/0092665 A1
(43) Pub. Date: May 5, 2005

(54) Water filter manifold with integral valve

(76) Inventor: Richard A. Kirchner, Apple Valley, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/929,343

(22) Filed: Aug. 27, 2004

Related U.S. Application Data
(60) Provisional application No. 60/498,013, filed on Aug. 27, 2003.

(51) Int. Cl. B01D 17/12

(52) U.S. Cl. 210/134; 210/123; 210/257.1; 210/420

(57) ABSTRACT

A water filtration system including a manifold assembly and a cartridge filter for reducing water system leaks and reducing installation time. The manifold assembly including at least a first inline valve eliminates the need for valve connections downstream of a water filtration system. The manifold assembly can includes an inlet flow circuit, a distribution flow circuit and at least a first in-line valve. The first in-line valve can include a valve stop located within the distribution circuit. The distribution circuit can include an integral valve seat such that positioning the valve stop with respect to the integral valve seat selectively controls water flow. The first in-line valve can have a control element allowing for external control. The manifold assembly can further include a second in-line valve having a second valve stop located within the distribution circuit. Both the first and second in-line valves can be solenoid valves.

### PRIORITY CLAIM

The present application claims priority to U.S. Provisional Application No. 60/498,013, entitled “WATER FILTER MANIFOLD WITH INTEGRAL VALVE,” filed Aug. 27, 2003, the disclosure of which is hereby incorporated by reference to the extent not inconsistent with the present disclosure.

### FIELD OF THE DISCLOSURE

The present disclosure relates generally to the field of water filtration systems. More specifically, the present disclosure relates to a water filter manifold including at least one integral distribution valve, which may facilitate installation of water filtration systems, such as, for example in consumer residences.

### BACKGROUND OF THE DISCLOSURE

Water filtration systems designed for use in the home, such as, for example, refrigerator and under-sink systems can be used to remove contaminants from water supplies. Due to increasing quality and health concerns with regard to municipal and well-water supplies, the popularity of such filtrations systems has increased markedly in recent years. For example, the inclusion of water filtration systems in refrigerators, once considered a luxury feature, is now included as a standard feature in all but entry level refrigerator designs.

A typical residential water filtration system generally includes a distribution manifold configured to accept a (prepackaged) specifically designed cartridge filter. The distribution manifold is typically adapted to operatively connect either directly or indirectly to the residential water supply and to points of use and may even allow for a drain connection. Generally, the prepackaged specifically designed cartridge filter sealingly engages the distribution manifold such that an inlet flow channel connecting the residential water supply and the cartridge filter is defined, and at least one outlet flow channel connecting the cartridge filter and the points of use and/or the drain is defined.

In some current water filtration system designs, the distribution manifold includes a pair of outlet flow paths for distributing filtered water. Generally, one of the outlet flow paths supplies water to an automated ice maker while the second outlet flow path supplies water to a user operated faucet for delivering filtered water for drinking, cooking or a variety of alternative uses. To properly channel filtered water through the appropriate filtered water outlet channel, water filtration systems typically include valves mounted between the distribution manifold and the points of use. These valves are separately installed and require additional time to individually wire and leak check.

### SUMMARY OF THE DISCLOSURE

A representative water filtration system of the present disclosure includes, but is not limited to, a distribution manifold providing for the fast, reliable installation of water filtration systems having a reduced number of downstream connections. Generally, the distribution manifold of the present disclosure is presently preferably manufactured to include one or more in-line valves as integral components of the distribution manifold such that there is no requirement for the inclusion of additional valves downstream of the water filtration system. The in-line valve comprises a relatively compact configuration and mounts directly with the flow system due to the incorporation of the valve seal within the flow channel. The in-line valve may comprise a solenoid valve with a communications assembly allowing the in-line valve to be opened and closed in response to an external input.

In one aspect, the present disclosure is directed to a water filtration system comprising a cartridge filter and a manifold. The cartridge filter comprises a filter circuit while the filtration manifold comprises an inlet circuit and a distribution circuit wherein the filter circuit, inlet circuit and the distribution circuit define a system flow circuit. The filtration manifold comprises at least a first in-line valve such that a valve stop is located within the system flow circuit. The valve stop selectively opens and seals with respect to a valve seat integral to the system flow circuit.

In another aspect, the present disclosure is directed to a water filtration manifold having an inlet fluid circuit and a distribution fluid circuit. The manifold can be connectable, such as rotationally or linearly, to a cartridge filter such that a system flow circuit is defined. The manifold includes at least one in-line valve that is selectively opened or closed based upon an external input to the in-line valve.

In a further aspect, the present disclosure is directed to a method for reducing the installation time of a water filtration system through the use of a manifold assembly incorporating at least one in-line valve.

Furthermore, the present disclosure is directed to a connector structure for connecting tubing, the connector comprising a male connector body and a female connector body. The male connector body comprises a first internal throughbore and an insertion portion with a, presently preferably, tapered tip having a relatively larger external diameter as compared to the axis of the taper and a retention portion, presently preferably, defined by a circumferential flange. The female connector body comprises a second internal throughbore, an internal circumferential recess and a plurality of retaining members. A length of tubing can be slidingly inserted through the second internal throughbore, and the length of tubing can slidingly engage the insertion portion with the tapered tip residing within the length of tubing. The tubing, presently preferably, has an internal diameter less than the largest diameter of the tapered tip resulting in an expansion of the tubing diameter over the insertion portion. The male connector body is operably connected with the female connector body by sliding the insertion portion into the female connector body such that the plurality of retaining members engage the circumferential flange thereby securely engaging the tubing against the tapered tip.

The above summary of the various aspects of the present disclosure is not intended to describe in detail each illustrated embodiment or the details of every implementation of the present disclosure. The figures in the detailed description that follow more particularly exemplify these representative embodiments. These, as well as other objects and advantages of the present disclosure, will be more completely understood and appreciated by referring to the following more detailed description of the described representative, exemplary embodiments of the present disclosure in conjunction with the accompanying drawings.

### BRIEF DESCRIPTION OF THE DRAWINGS

FIG. 1 is a schematic representation of a representative water filtration system of the present disclosure.

FIG. 2 is an exploded, perspective view of an embodiment of a distribution manifold of the present disclosure.

FIG. 3 is an exploded, perspective view of an alternative embodiment similar to the distribution manifold of FIG. 2.

FIG. 4 is an end view of the distribution manifold of FIG. 2.

FIG. 5 is a sectional view of the distribution manifold of FIG. 2 taken along line 5-5 in FIG. 4.

FIG. 6 is a sectional view of the distribution manifold of FIG. 2 taken along line 6-6 in FIG. 4.

FIG. 7 is an expanded, fragmentary, sectional view of the distribution manifold of FIG. 2 taken at C in FIG. 5.

FIG. 8 is an expanded, fragmentary, sectional view of the distribution manifold of FIG. 2 taken at B in FIG. 5.

FIG. 9 is an end view of a valve plunger assembly for use in the distribution manifold of FIG. 2.

FIG. 10 is a sectional view of the valve plunger assembly of FIG. 9 take along line 10-10.

FIG. 11 is a side view of an embodiment of a connector in a closed configuration for connecting tubing to a flow circuit.

FIG. 12 is a perspective view of the connector of FIG. 11.

FIG. 13 is a side view of the connector of FIG. 11 in an open configuration.

FIG. 14 is a perspective view of the connector of FIG. 13.

FIG. 15 is a sectional view of a male portion of the connector of FIG. 11.

FIG. 16 is an end view of a female portion of the connector of FIG. 11.

FIG. 17 is a sectional view of the female portion taken along line 17-17 of FIG. 16.

FIG. 18 is a sectional view of an alternative embodiment of the male portion of the connector of FIG. 11.

### DETAILED DESCRIPTION OF PRESENTLY PREFERRED REPRESENTATIVE EMBODIMENTS

An improved water filtration manifold for use in conjunction with a water filter for filtering water in a residential water filtration system generally comprises a selectively actuated valve within a manifold flow channel. Generally, the manifold can be operatively connected to a cooperative element, such as the interior of an appliance or a cabinet, such that the replaceable cartridge filters can be selectively operatively connected and detached from the manifold as the filtering capacity of the cartridge filter is consumed or exhausted. The manifold comprises a fastener component that cooperates with a compatible fastener component operatively positioned on the cartridge filter to create an operable water filtration system. The manifold also includes inlet and outlet flow channels that define continuous flow paths from a water source, through the water filtration system and to points of use or to a drain. The manifold can also be used in embodiments separate from an appliance or cabinet, such as embodiments with a support stand or the like for free standing or mounted placement in other convenient locations.

The distribution manifold, as described herein, comprises an integral in-line valve located within the flow channels, such as, for example, an outlet flow channel. The function of the outlet valves is to provide for the delivery of filtered water to points of use based on inputs from an end use location, such as, for example, from a water tap, or from an automated input, such as, for example, from an automated ice machine. The outlet valves are, presently preferably, integral components of the distribution manifold such that no significant additional installation time is required to install stand-alone valves and such that the number of potential leak points within the water filtration system is reduced. In some presently preferably representative embodiments, the distribution manifold comprises a plug-style connector for completing a control circuit between the inputs and the outlet valves such that individual wiring of the outlet valves is not required. In one representative embodiment, the outlet valve comprises an in-line solenoid valve. However, other in-line valves having assembly characteristics that result in the desired performance could be used as well.

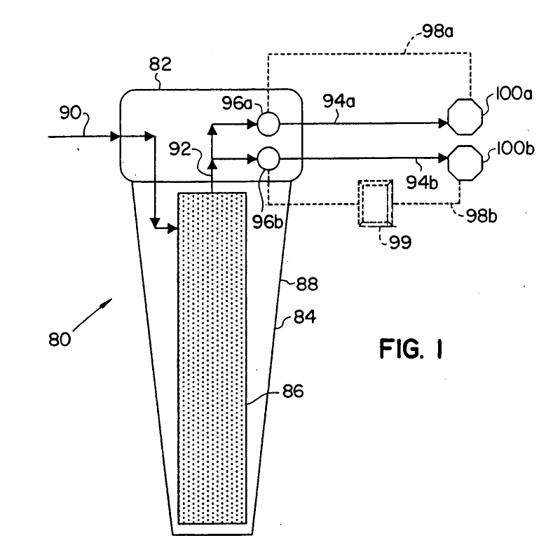

A representative water filtration system 80 of the present disclosure is illustrated schematically in FIG. 1. Water filtration system 80 comprises a manifold assembly 82 and a cartridge filter 84. The cartridge filter 84 typically comprises a specifically designed, prepackaged filter having a filter element 86 operatively positioned within a cartridge housing 88. It is presently envisioned that the filter element 86 may comprise any suitable filtering media, such as but not limited to, activated carbon media, absolute filtration media, depth filtration media, ion exchange media and membrane filtration media including reverse osmosis and similar cross-flow filtration media.

As illustrated in a filtering embodiment, an inlet water stream 90 flows into the manifold assembly 82 at which point the inlet water steam 90 can be directed into the cartridge filter 84. Within the cartridge filter 84, the inlet water stream 90 is directed through the filter element 86 wherein impurities present within the inlet water stream 90 are removed and the filtered water exits the filter cartridge as a filtered water stream 92. The filtered water stream 92 can optionally be divided into any number of distribution streams 94a, 94b using a like number of inline valves 96a, 96b, although, in some representative alternative embodiments, a single distribution stream can be use with a water dispenser, an ice maker or the like. Distribution steams 94a, 94b can then be directed to points-of-use, such as, but not limited to, a water tap 100a, an ice maker 100b or other similar points-of-use. Water tap 100a can selectively open and close in-line valve 96a through a control circuit 98a while ice maker 100b can selectively open and close in-line valve 96b through a control circuit 98b. In some embodiments, control circuit 98b can also comprise a controller 99, for example a microprocessor or programmable logic controller (PLC).

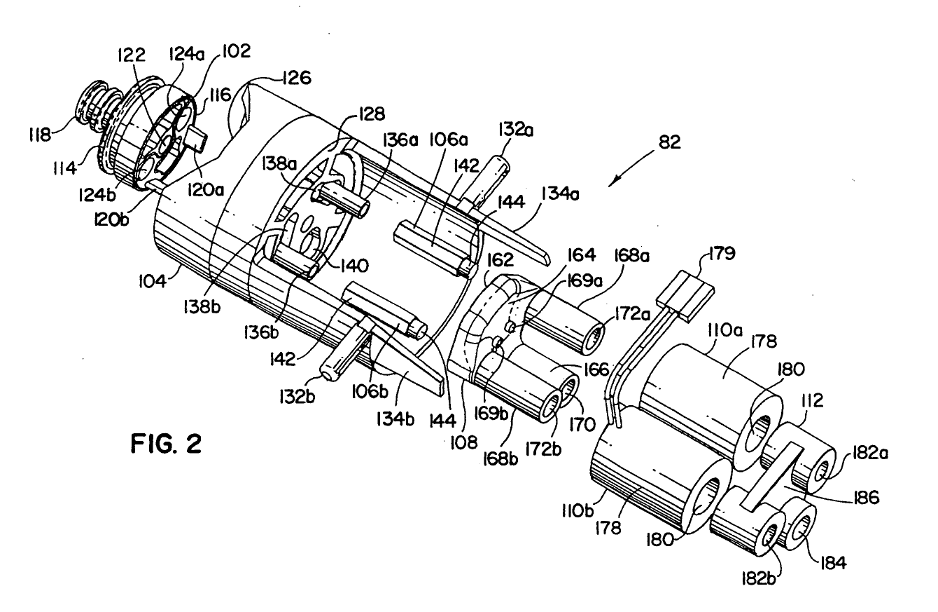

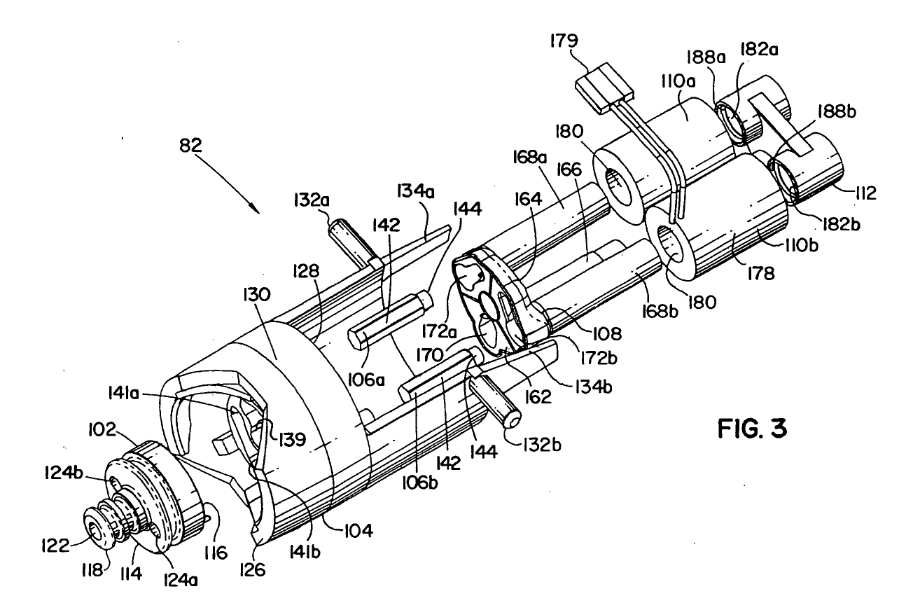

As illustrated in FIGS. 2 and 3, one representative manifold assembly 82 comprises a filter interface 102, a manifold body 104, a pair of valve plungers 106a, 106b, a valve body 108, a pair of solenoid coils 110a, 110b and a tubing retainer 112.

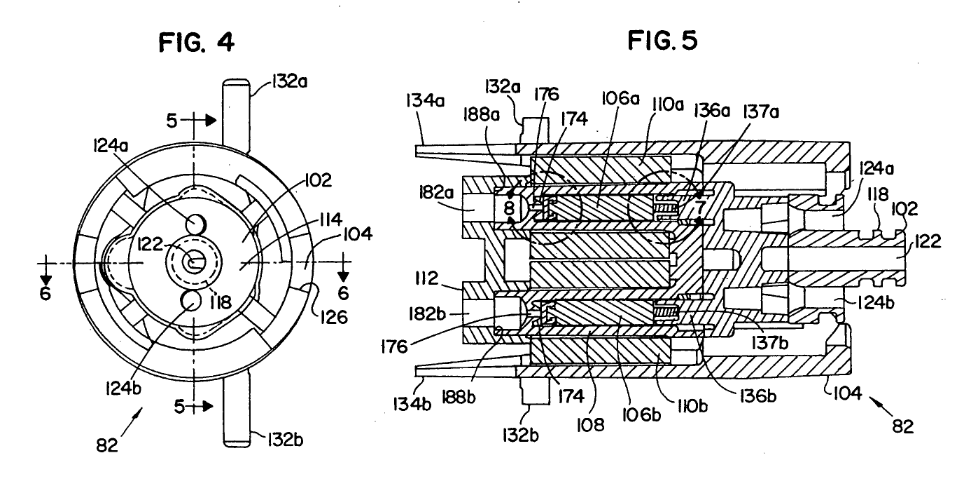

Filter interface 102 comprises a filter insertion portion 114 and a manifold attachment portion 116. Filter insertion portion 114 comprises an insertion projection 118 adapted for insertion into the cartridge filter 84. Manifold attachment portion 116 comprises a pair of interface members 120a, 120b. Filter interface 102 comprises a filtered water throughbore 122 and a pair of unfiltered water throughbores 124a, 124b, each of these throughbores connecting the filter insertion portion 114 with the manifold attachment portion 116 as illustrated in the end view of FIG. 4.

Referring to FIGS. 2 and 3, manifold body 104 comprises a filter engagement portion 126, a distribution portion 128, an arcuate housing surface 130, a pair of mounting members 132a, 132b and a pair of rotation stops 134a, 134b. Distribution portion 128 has a pair of hollow-ended projections 136a, 136b, each including a spring 137a, 137b. Distribution portion 128 further includes a pair of filtered water throughbores 138a, 138b and an unfiltered water throughbore 140. Within manifold body 104, filtered water throughbores 138a, 138b are merged to present a single filtered water throughbore 139 on filter engagement portion 126 corresponding to filtered water throughbore 122 while unfiltered water throughbore 140 is divided into two unfiltered water throughbores 141a, 141b on filter engagement 126 corresponding to unfiltered water throughbores 124a, 124b. As described further below, the configuration of the filter insertion portion 114 can be modified appropriately to account for different filter designs with corresponding different filter flow circuits and/or filter attachment mechanisms.

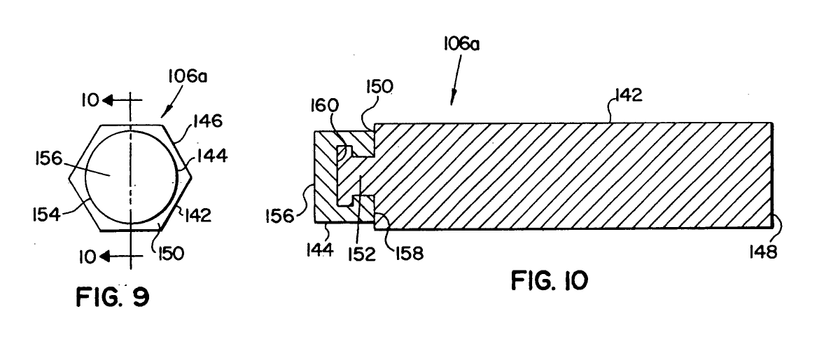

While valve plunger 106a is further described and depicted with respect to a specific embodiment, it will be understood that valve plunger 106b can have other designs within the skill in the art for incorporation into suitable in-line valves based on the disclosure herein. Valve plunger 106a as illustrated in FIGS. 2, 3, 9 and 10 comprises a plunger member 142 and a plunger seal 144. As depicted, plunger member 142 has a hexagonal cross-section 146 though other geometric cross-sections such as circular or octagonal are envisioned. Plunger member 142 further comprises a biasing portion 148 and a sealing portion 150. Sealing portion 150 comprises an attachment member 152. Plunger seal 144 generally has a circular cross-section 154 as well as a sealing portion 156 and an attachment portion 158. Attachment portion 158 includes a central recess 160 adapted for sealing engagement with attachment member 152. Plunger seal 144 generally is formed from a suitable elastomeric material, such as, for example, an elastomeric polymer, including, but not limited to, for example natural and/or synthetic rubbers or the like. Plunger member 142 can be formed from a suitable material for use with the solenoid coils, such as, for example, a magnetizable metal, for example, a ferrous metal, such that the plunger member can be moved with a magnetic field generated with solenoid coils.

Valve body 108 comprises a connecting portion 162 and a mounting portion 164. Mounting portion 164 includes three tubular projections including an inlet projection 166 and a pair of outlet projections 168a, 168b as well as a pair of projecting tabs 169a, 169b. Inlet projection 166 defines a continuous inlet throughbore 170 extending to connecting portion 162 and corresponding to unfiltered water throughbore 140. Outlet projections 168a, 168b define continuous outlet throughbores 172a, 172b extending to connecting portion 162 and corresponding to filtered water throughbores 138a, 138b. Outlet projections 168a, 168b have an interior diameter dimensioned to accommodate hollow-ended projections 136a, 136b and valve plungers 106a, 106b. As illustrated in FIGS. 5 and 8, both outlet projection 168a and 168b include an angled interior surface 174 with an interior throughbore 176. Sealing portion 156 of plunger seal 144 has a size and shape to sealingly engage the tip of angled interior surface 174.

As illustrated, solenoid coils 110a, 110b comprise standard, copper wound coil windings encapsulated within a plastic body 178 or other appropriate materials. A plug connector 179 is typically wired to solenoid coils 110a, 110b to facilitate operative connection with a control circuit (not depicted). Solenoid coils 110a, 110b generally have a circular cross-section, each having a coil throughbore 180 with a circular cross-section. Coil throughbore 180 is dimensioned so as to have an inner diameter slightly larger than the outer diameter of outlet projections 168a, 168b.

While the valve is illustrated as a particular solenoid valve having specific advantages, other embodiments of the valve can be used. For example, in some possible embodiments, a valve is integral with the manifold in that the valve seat is molded into a monolithic structure with a flow channel. This integral valve may or may not have a valve closure element in-line with the flow channel. For example, in one possible alternative embodiment, the integral valve may have a rotating valve closure member that rotates against the valve seat to open or close the valve by positioning a valve channel through the ball member appropriately. In other possible embodiments, the valve comprises an in-line valve closure element that is not actuated with a solenoid coil. For example, an in-line valve closure element has a valve member that moved up to or away from a valve seat by motion along the axis of the flow. While the motion can be controlled with a solenoid coil to eliminate a connection through the wall of the flow channel to the valve element, a mechanical member can be used to move the in-line valve element, such as, for example, by rotating an asymmetrical knob that contacts a surface of the flow element to move the flow element along the flow path. The mechanical connection to the asymmetrical knob exits the flow channel through a sealed opening to a stepper motor or other suitable motor. It is believed that a considerable number other possible embodiments incorporating the teachings of the present disclosure can be readily designed by a person of ordinary skill in the art based on the present disclosure.

As illustrated in FIGS. 2-6, tubing retainer 112 comprises a pair of retainer outlet bores 182a, 182b, a retainer inlet bore 184 and a retainer body 186. Retainer outlet bores 182a, 182b each include an interior circumferential flange 188a, 188b, as illustrated in FIG. 5, while retainer inlet bore 184 includes a similar interior circumferential flange 190 as illustrated in FIG. 5. Retainer outlet bores 182a, 182b and retainer inlet bore 184 are dimensioned to have an interior diameter slightly greater than outlet projections 168a, 168b and inlet projection 166.

In general, manifold assembly 82 is assembled such that the combination of filter interface 102, manifold body 104, valve plungers 106a, 106b, valve body 108, solenoid coils 110a, 110b and tubing retainer 112 define a functional manifold having a single unfiltered water inlet flow path and at least one and possibly more filtered water outlet flow paths, with a pair of outflow paths being illustrated in the Figures. Filter interface 102 is positioned such that manifold attachment portion 116 is in proximity to filter engagement portion 126 on manifold body 104. Interface members 120a, 120b are guided into a pair of bores (not shown) presented on filter engagement portion 126 such that filtered water throughbore 122 is aligned with the single filtered water throughbore 139 on the filter engagement portion 126 while the unfiltered water throughbores 124a, 124b are aligned with the pair of unfiltered water throughbores 141a, 141b on the filter engagement portion 126. Filter interface 102 is operatively connected to manifold body 104 using any suitable bonding process, such as, for example, sonic welding, adhesives or a combination of suitable bonding processes.

Next, valve plungers 106a, 106b are inserted into the outlet projections 168a, 168 from the connecting portion 162 of valve body 108 such that the plunger seal 144 is in proximity to the angled interior surface 174 in each interior throughbore 176. Valve body 108 is then positioned such that connecting portion 162 is in proximity to distribution portion 128 with hollow-ended projections 136a, 136b located within outlet projections 168a, 168b. Valve body 108 is operatively connected to manifold body 104 using a suitable bonding process such as sonic welding, adhesives or a combination of suitable bonding processes. When operatively connected, outlet flow paths are defined between filtered water throughbores 138a, 138b and outlet throughbores 172a, 172b while an inlet flow path is defined between inlet throughbore 170 and unfiltered water throughbore 140.

Once valve body 108 is operatively connected to manifold body 104, solenoid coils 110a, 110b can be operatively positioned such that their coil throughbores 180 are operatively positioned with outlet projections 168a, 168b inserted within the interior of the coils. Specifically, solenoid coil 110a slides over outlet projection 168a while solenoid coil 110b slides over outlet projection 168b. Solenoid coils 110a, 110b are held in operative position by operatively positioning tubing retainer 112 such that the ends of outlet projections 168a, 168b slide into retainer outlet bores 182a, 182b while the end of inlet projection 166 slides into inlet bore 184. Tubing retainer 112 and outlet projections 168a, 168b as well as inlet projection 166 are operatively connected by a suitable bonding process such as sonic welding, adhesives or a combination of suitable bonding processes.

The tubing can include, but is not limited to, a barbed end for insertion into the retainer outlet bores 182a, 182b and inlet bore 184 such that the barb is retained by the tubing retainer 112 as described in U.S. patent applications Ser. Nos. 09/918,316 and 10/210,890, both of which are hereby incorporated by reference to the extent not inconsistent with the present disclosure. Generally, the bonding process that secures tubing retainer 112 to valve body 108 results in a permanent connection between the barbed tubing and the manifold assembly 82.

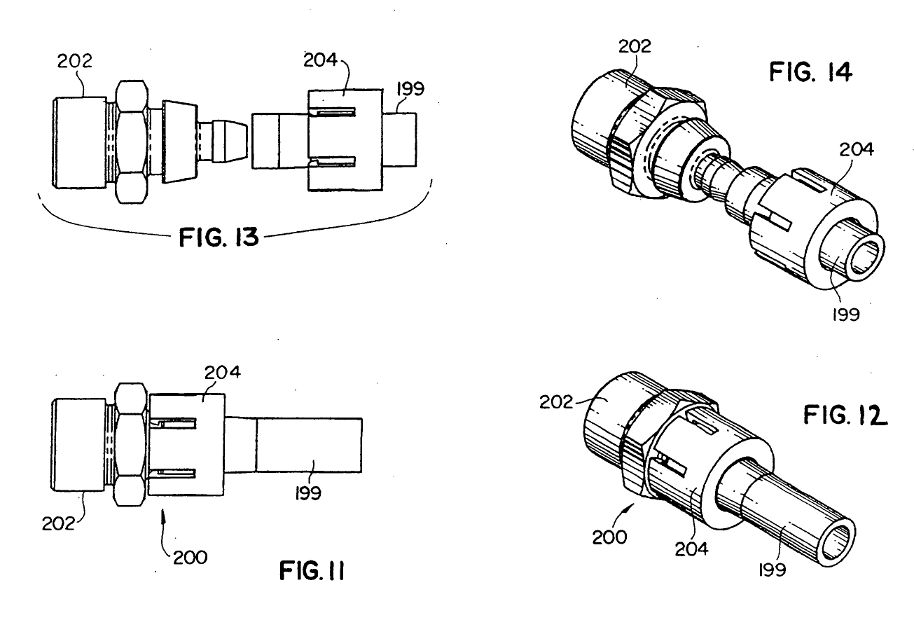

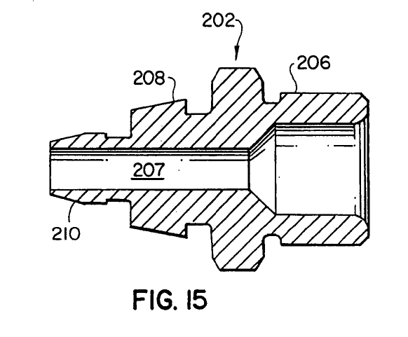

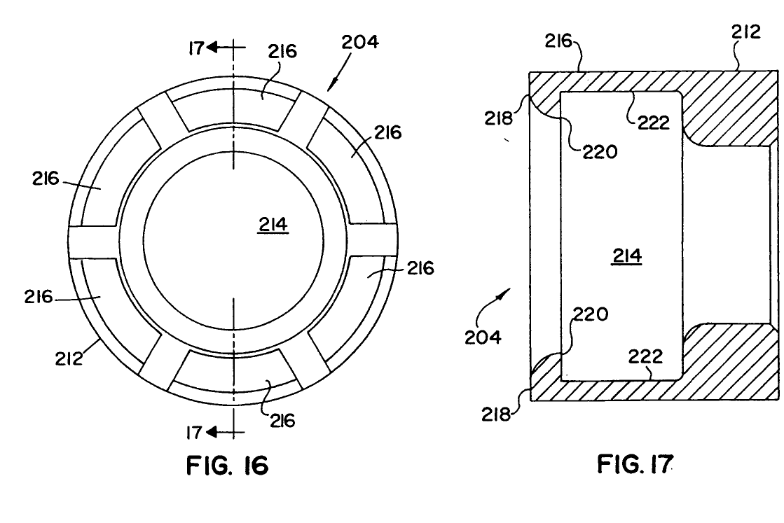

Alternatively, retainer outlet bores 182a, 182b and inlet bore 184 can be configured for a snap closure attachment with a length of non-barbed tubing 199 using a connector 200 as depicted in FIGS. 10-17. Connector 200 comprises a male connector 202 and a female connector 204. Connector 200 can be machined from brass or other suitable metals or may be molded with appropriate polymers such as polyethylene, polypropylene, nylon, fluorinated polymers and the like. Generally, tubing retainer 112 can be molded such that retainer outlet bores 182a, 182b and inlet bore 184 take the form of male connector 202. As illustrated in FIG. 15, male connector 202 comprises a connector body 206, a male connector throughbore 207, a circumferential flange 208 and an insertion member 210. As illustrated in FIGS. 16 and 17, female connector 204 comprises a retainer body 212, a retainer throughbore 214 and a plurality of retaining members 216. Retaining member 216 comprises a retaining tip 218 including an internal protrusion 220, which defines a retaining recess 222 as illustrated in FIG. 17. Generally, female connector 204 is operatively associated with the tubing 199 as depicted in FIGS. 11, 12, 13 and 14. Tubing 199 is then operatively positioned over insertion member 210, which expands the end of the tubing since the diameter of insertion member 210 is greater than the internal diameter of the tubing. Finally, female connector 204 is directed toward male connector 202 such that the retaining tips 218 of retaining members 216 latch around circumferential flange 208 resulting in a secure, operative connection between tubing 199 and the manifold assembly 82. When female connector 204 is snapped onto flange 208, female connector 204 wedges the tubing against insertion member 210 such that the tubing cannot be pulled free from insertion member 210 using reasonable force. While connector 200 is described for the connection of tubing to the manifold, this connector can be adapted for use with other connections between a pipe and an elastic tubing to form a secure connection, based on the disclosure herein. Male connector element 202 can be operatively secured to the manifold using an appropriate bonding approach, such as, for example, sonic welding, friction welding, spin welding, thermal welding, adhesive bonding or the like.

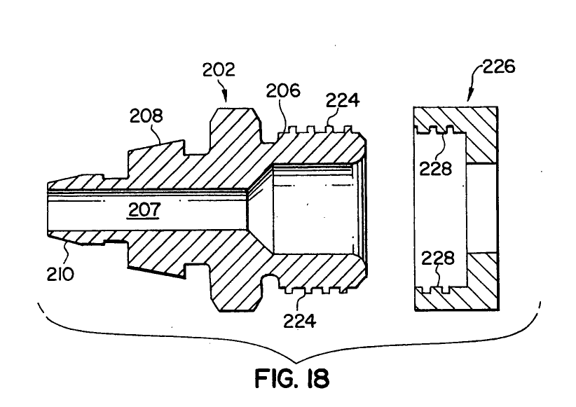

In one possible alternative embodiment illustrated in FIG. 18, a male connector 202 can include, but is not limited to, an external thread 224 on the connector body 206 allowing the connector 200 to be employed separately from the water filtration system 80, for example upstream of the water filtration system 80 to provide an operative connection between a rigid fresh water supply such as, for example, copper tubing and a flexible tube such as, for example, polyethylene tubing wherein the flexible tubing directs inlet water stream 90 into fluid communication with the water filtration system. In such an arrangement, a nut 226 having an internal thread 228 can be placed over the rigid fresh water supply. Rotationally engaging the external thread 224 and internal thread 228 results in a compression style connection between the male connector 202 and the rigid fresh water supply. Female connector 204 is placed over the flexible tube as previously described and female connector 204 and male connector 202 are operatively joined as previously described resulting in a leak resistant connection between the rigid fresh water supply and the flexible tube.

Once assembled, manifold assembly 82 defines a continuous inlet flow path from inlet bore 184, through inlet throughbore 170, into unfiltered water throughbore 140 where it is subsequently divided into unfiltered water throughbores 124a, 124b and into an operatively connected cartridge filter. As illustrated, a pair of outlet flow paths are defined starting with filtered water throughbore 122 which is separated into filtered water throughbores 138a, 138b which flow into outlet projections 168a, 168b and finally to points of use through retainer outlet bores 182a, 182b.

In use, manifold assembly 82 can be a component in the water filtration system 80 that can also include but is not limited to, inlet and outlet tubing, the cartridge filter 84 and some form of controller, either automatic or manual. Generally, manifold assembly 82 is mounted to a cooperative element, for example the interior of a refrigerator, using mounting members 132a, 132b operatively connected directly to a mounting surface or to some form of mounting bracket. Mounting members 132a, 132b can be cylindrical such that manifold assembly 82 can rotate about mounting members 132a, 132b such that attaching or removing cartridge filters is made easier by rotating the water filtration system away from the mounting surface. Rotation of the water filtration system is typically limited through contact of rotation stops 134a, 134b with the mounting surface.

The cartridge filter 84 can be operatively connected to the manifold assembly 82 using the features present on the filter interface 102 and manifold body 104 and features present on the cartridge filter 84. Rotational attachment of the cartridge filter 84 to the manifold assembly 82 can take many forms, for example the forms depicted and describe in U.S. patent applications Ser. Nos. 09/618,686, 10/196,340, both of which are hereby incorporated by reference to the extent not inconsistent with the present disclosure. In one possible representative alternative arrangement, cartridge filter 84 and manifold assembly 82 can be linearly engaged using the forms and features described in U.S. patent application Ser. No. 10/210,890, which is hereby incorporated by reference to the extent not inconsistent with the present disclosure.

Solenoid coils 110a, 110b are generally wired to a control circuit using plug connector 179 such that an external input from the control circuit can energize the solenoid coils 10a, 110b. Through the use of plug connector 179, manifold assembly 82 can be integrated quickly, easily and reliably with a variety of potential control inputs. In one embodiment, the external input can comprise a manually generated input such as a water tap, push-button or lever, that a user interfaces with when filtered water is desired. In another possible representative embodiment, the external input comprises an automatically generated input from an automated system, such as controller 99 for example, a microprocessor or PLC or other automated system such as an ice maker or a storage tank with a level switch, that requests filtered water as part of its automated function. In this manner, the energizing of solenoid coils 110a, 110b can be both manually and automatically initiated either simultaneously or independently of one another.

Generally, when the solenoid coils 10a, 10b are not energized, valve plungers 106a, 106b are directed by springs 137a, 137b located between the plunger members 142 and hollow-ended projections 136a, 136b such that plunger seals 144 sealingly engage the angled interior surfaces 174, as illustrated in FIGS. 4 and 7, thus preventing filtered water from flowing though the interior throughbores 176. Alternatively, the flow itself can close the valve unless deflected by the solenoid coil, as described below.

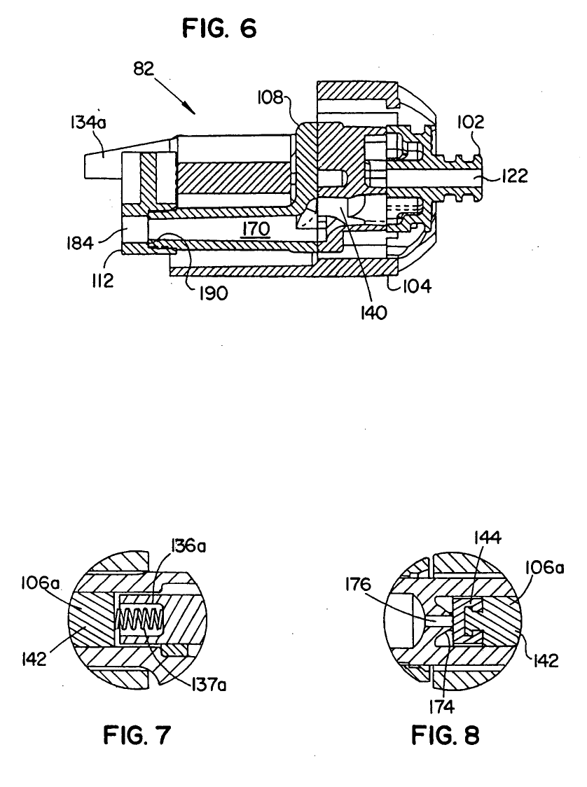

When one or both of solenoid coils 110a, 110b are energized, a magnetic field is created by the copper windings. With respect to valve member 106a for example, the magnetic properties of plunger member 142 cause valve member 106a to be aligned within the induced magnetic field. Proper positioning of the magnetic field is accomplished through the interaction of projecting tabs 169a with solenoid coil 110a during the assembly process. As such, the spring 137a between plunger member 142 and hollow-ended projection 136a is compressed as illustrated in FIG. 6. In this position, filtered water flows past valve member 106a, through interior throughbore 176 and on to the point of use, for example, water tap 100a. Solenoid coil 110b and valve member 106b function in an equivalent manner.

By incorporating valve members 106a, 106b or the like into manifold assembly 82, the use of separate, individual valves downstream of the water filtration assembly can be avoided or at least reduced. This can result in fewer connections and assembly parts which can subsequently reduce assembly costs as well as eliminating potential leak points.

While the present disclosure is amenable to various modifications and alternative forms, specifics thereof have been shown by way of example in the drawings and have been described in detail. It should be understood, however, that the intention is not to limit the present disclosure to the particular embodiments described. On the contrary, the intention is to cover all modifications, equivalents, and alternatives falling within the spirit and scope of the present disclosure as defined by the appended claims.

1. A water filtration system comprising:
a cartridge filter having a filter flow circuit;
a manifold support structure having an inlet flow circuit and a distribution flow circuit; and
at least a first inline valve comprising a valve stop and control elements operably connected to the valve stop to selectively move the valve stop between and open flow position and a closed flow position,
wherein the cartridge filter is operably connected to the manifold such that a system flow circuit is defined by the inlet flow circuit, the filter flow circuit and the distribution flow circuit; and
wherein the valve stop of the first inline valve is integrally mounted in the system flow circuit within the manifold support structure.

2. The water filtration system of claim 1, wherein the distribution flow circuit comprises at least a first distribution flow circuit and a second distribution flow circuit and wherein the first inline valve interfaces with the first distribution flow circuit.

3. The water filtration system of claim 2, further comprising a second inline valve, the second inline valve comprising: a second valve stop, wherein the second valve stop interfaces with the second distribution circuit.

4. The water filtration system of claim 1, wherein open flow position and the closed valve position of the valve stop differ by a translation along the flow path of the distribution flow circuit.

5. The water filtration system of claim 1, wherein the first inline distribution valve comprises: a solenoid valve.

6. The water filtration system of claim 5, wherein the control elements comprise an electrical connector for interfacing the first inline valve with an external control input.

7. The water filtration system of claim 6, wherein the external control input is supplied from a controller comprising a manual input or an automated input.

8. The water filtration system of claim 7, wherein the manual input comprises a manual tap or a pushbutton.

9. The water filtration system of claim 7, wherein the automated input comprises an automated signal from a PLC, a microprocessor, an ice maker controller or a float switch of a storage tank.

10. The water filtration system of claim 1, wherein the system flow circuit comprises an integral valve seat wherein the valve seal selectively seals against the integral valve seat.

11. A water manifold comprising:
a manifold body having an inlet and at least one outlet, the inlet being fluidly connected to an inlet flow circuit and the at least one outlet being fluidly connected to a distribution flow circuit, the manifold body further including at least a first in-line valve comprising a valve stop and control elements, the valve stop being integrally mounted within the distribution flow circuit or the inlet flow circuit, and the valve stop having an open flow position and a closed flow position that differ from each other according to a translation of the valve stop along the flow direction.

12. The water manifold of claim 11, wherein the distribution flow circuit comprises a first distribution flow circuit and a second distribution flow circuit and wherein the first inline valve interfaces with the first distribution flow circuit.

13. The water manifold of claim 12, further comprising a second in-line valve comprising a second valve stop and wherein the second valve stop interfaces with the second distribution flow circuit.

14. The water manifold of claim 11, further comprising a filter mount.

15. The water manifold of claim 11, wherein the first in-line valve comprises a solenoid valve.

16. The water manifold of claim 11, wherein the control elements comprise an electrical connector for interfacing the first in-line valve with an external control input.

17. The water manifold of claim 16, wherein the external control input is supplied from a controller having a manually initiated input or an automatically initiated input.

18. The water manifold of claim 17, wherein the manually initiated input comprises a water tap or a push button.

19. The water manifold of claim 17, wherein the automatically initiated input comprises a signal from a programmable logic controller, a microprocessor, an ice maker controller, a pressure switch or a level switch.

20. The water manifold of claim 11, wherein the distribution flow circuit comprises an integral valve seat wherein the valve stop selectively seals against the integral valve seat.

21. A method for installing a water filtration system comprising:
connecting a filter manifold to an inlet water supply and at least one distribution line, the filter manifold having an inlet flow circuit and a distribution flow circuit within the filter manifold and wherein a first inline valve is integrally located within the inlet flow circuit or the distribution flow circuit and wherein the attachment of a filter cartridge to the filter manifold forms a filtering circuit wherein the interaction of the inlet circuit, the filtering circuit and the distribution circuit define a system flow circuit.

22. The method of claim 21, wherein the valve member can be selectively positioned between an open valve position and a closed valve position.

23. The method of claim 21, further comprising positioning a second valve member of a second inline valve within the distribution circuit, the second valve member selectively opening and sealing against a second integral valve seat within the distribution circuit.

24. A connector for connecting tubing, comprising:
a male connector body comprising a first internal throughbore, the male connector body having an insertion portion with a tapered tip having a larger external diameter relative to the axis of the taper and a retention portion defined by a circumferential flange; and
a female connector body comprising a second internal throughbore, the female connector body comprising an internal circumferential recess and a plurality of retaining members,
wherein a length of tubing is slidingly inserted through the second internal throughbore,
wherein the length of tubing is slidingly engage the insertion portion with the tapered tip residing within the length of tubing, the tubing having an internal diameter less than the largest diameter of the tapered tip resulting in an expansion of the tubing diameter over the insertion portion; and
wherein the male connector body is operably connected with the female connector body by sliding the insertion portion into the female connector body such that the plurality of retaining members engage the circumferential flange securely, operatively engaging the tubing against the tapered tip.

25. The connector of claim 24 wherein the male connector body defines a fluid connection on a filtration manifold.

26. The connector of claim 24 wherein the male connector body further comprises an external thread such that the external thread is engageable with a nut on a rigid line, the nut engaging the external thread such that the male connector body is operably connected to the rigid line such that the rigid line can be fluidly joined to the length of tubing.

27. The connector of claim 24, wherein the male connector body and the female connector body are molded from a polymer selected from the group comprising: polyethylene, polypropylene, nylon and fluorinated polymers.
